(19) United States
(12) Patent Application Publication
(10) Pub. No.: US 2025/0181864 A1
(43) Pub. Date: Jun. 5, 2025

(54) Inspection Device and Method

(71) Applicants: Thomas Huhn, München (DE); Nikolas Estner, München (DE); Pedro Eid, Indian Rocks Beach, FL (US)

(72) Inventors: Thomas Huhn, München (DE); Nikolas Estner, München (DE); Pedro Eid, Indian Rocks Beach, FL (US)

(73) Assignee: Emhart Glass SA, Steinhausen (CH)

(21) Appl. No.: 19/050,488

(22) Filed: Feb. 11, 2025

Related U.S. Application Data
(63) Continuation of application No. PCT/EP2023/071172, filed on Jul. 31, 2023.

(30) Foreign Application Priority Data
Aug. 11, 2022 (DE) 102022120354.9

(51) Int. Cl. G06K 7/14; G06K 19/06

(52) U.S. Cl. CPC G06K 7/1491; G06K 19/06159

(57) ABSTRACT

In a method for reading a code arranged on a wall of a container, an illuminated region is generated on the container wall by means of a light source, a width of the illuminated region being smaller than a width of the code surface area in a circumferential direction of the container. In connection with a relative movement between the container and the illuminated region, a series of individual frames of the illuminated region is captured by means of a matrix camera. An image of the code is assembled from the series of individual frames. The invention also relates to a device for reading a code arranged on a wall of a container.

### CROSS-REFERENCE TO RELATED PATENT APPLICATIONS

This Patent Application is a Continuation of PCT Patent Application No. PCT/EP2023/071172, filed Jul. 31, 2023, which claims priority to German Patent Application No. 102022120354.9, filed Aug. 11, 2022, the entire teachings and disclosure each of which are incorporated herein by reference thereto.

### FIELD OF THE INVENTION

The present invention relates to a method for reading a code arranged on a wall of a container, the code occupying a code surface area on the wall of the container. The present invention also relates to a corresponding device.

### BACKGROUND OF THE INVENTION

A method and a device for reading a code occupying a code surface area on a container, in particular a bottle or some other glass container, is disclosed by EP 2 297 672 B1. EP 2 297 672 B1 emphasizes how important it is that the surface of the code is fully covered by an illumination of the light source during recording, so that all parts of the code can be read. US 2006/0091214 A1 discloses an apparatus for optically reading two-dimensional graphical codes from a surface, but has no particular relation to containers. U.S. Pat. No. 4,644,151 describes the optical reading of a code that extends in two rows around the lower end of a side wall of containers. A camera with a linear array of light-sensitive elements is there used for reading the code, the light intensity reflected by individual code elements being measurable by means of these light-sensitive elements.

Taking as a basis EP 2 297 672 B1, the problem to be solved is to develop a method and a device for reading a code on the wall of a container, which are as efficient, as reliable, as widely applicable and as easy to adjust as possible. In addition, the device should avoid the drawbacks of large dimensions of a light source that are adverse to the limited space available in a typical environment of use.

This object is solved by a method having the features of claim 1 and by a device having the features of claim 9. Advantageous further developments of the present invention are specified in the dependent claims.

The method according to the present invention provides that an illuminated region generated on the (in particular curved) wall of the container, e.g. a bottle or some other container, made of glass by way of example, has a width that is smaller than the width of the code surface area in the circumferential direction of the container. Hence, the present invention turns away from the aim of EP 2 297 672 B1, which is to always illuminate the code surface area all over.

In the context of the present invention, the term “illuminated region” refers to the region on the surface of the container in which, or from which light rays emanating from the light source are reflected onto the camera. The size of the illuminated region is thus determined by the dimensions of the light source, the curvature of the surface of the container and, possibly, the opening of a diaphragm in the beam path. The dimensions of this illuminated region can be limited or reduced in size by smaller dimensions of the light source, a larger curvature (i.e. a smaller radius of curvature) of the surface of the container and, possibly, by reducing the size of an opening of a diaphragm in the beam path. In the case of a container with a flat side wall, the “radius of curvature” of the wall is infinitely large.

The light emitted by the light source can and is allowed to be diffuse to a certain degree. Therefore, the illuminated region does not necessarily have a perfectly sharp boundary. In the context of the present invention, the “width” of the illuminated region is generally understood to mean the FWHM (full width at half maximum) of the illumination intensity (still captured by the camera) in the respective spatial direction. In the case of a container with a curved side wall, a sharply defined light edge may occur on the camera image-namely where the light coming from the light source is deflected so strongly to the side at the container wall that it radiates past the camera.

According to the present invention, a relative movement, preferably a translational and/or rotational relative movement, is generated between the container and the illuminated region and a series of individual frames of the illuminated region is captured by means of a matrix camera, with a relative movement between the container and the illuminated region taking place between individual frames of the series. Subsequently, or possibly even while the series of individual frames is being recorded, a (digital or virtual) image of the code is assembled from the individual frames. For example, either subsequent to or possibly even while the series of individual frames is being recorded, elements of the code are searched for in the individual frames, a virtual version of the complete code is generated in the memory from these elements, and, after completion, the code is read out. The image of the code can be digitally stored and read out separately. Alternatively, the assembly of the image of the code may already be equivalent to reading-out the code.

The present invention offers various advantages. According to the invention, the area of the illuminated region is limited to a comparatively small width. This has the advantage that the light yield is particularly high, so that either a high light intensity can be accomplished or, on the other hand, a less powerful, but particularly (energy-) efficient light source can be used. Since the required speed for capturing the code also requires a high speed of movement, it will be particularly advantageous when the exposure time of the individual frames can be particularly short, so as to prevent motion blur during recording to the greatest possible extent. For this purpose, a short illumination time with high light intensity, for example flash illumination, is well suited.

The assembly of an image of the code from a series of individual frames has, in turn, the advantage that the inspection of the code becomes independent of its actual size. In other words, the present invention allows codes with very differently sized code surface areas to be read, without any adaptation of the illumination width, which is required in the case of conventional methods, being necessary. The matrix camera used allows an image to be assembled in this way. For this purpose, the matrix camera should preferably have the property of being able to record individual frames at a very high frequency of several hundred or thousand hertz.

In particular transparent or translucent containers, made e.g. of glass, are suitable to be used as containers having a code arranged on their wall. These containers may be bottles.

Preferably, the code is configured as an arrangement of embossments and/or depressions in the wall of the container. The embossments or depressions may essentially be dot-shaped. It will suffice when, at the location of the embossment or depression, the reflectivity or transmissivity of the wall of the container differs compared to the neighboring areas of the wall. What is also suitable for recognizing the code is when the light incident from the illumination is deflected by the embossment or the depression in such a way that the light will not fall into the camera and will thus appear correspondingly dark in front of a bright environment generated by the light source.

Preferably, the code is formed as a matrix-shaped arrangement of such embossments and/or depressions, i.e. as an arrangement of n×m (n times m) image points, as disclosed in a similar way in EP 2 297 672 B1 and hereby incorporated by reference.

Preferably, at least one individual frame of the series, preferably all the individual frames of the series, overlap(s) with a respective neighboring individual frame. This facilitates the assembly (and reading) of an image of the code from the series of individual frames. Structures or individual areas of the code that can be found on the neighboring individual frames allow the precise assembly of the overall image. It is conceivable, for example, that neighboring individual frames overlap with a neighboring individual frame over up to 30%, up to 40% or even up to 50% (or more) of their respective individual surface area.

It may be expedient that the illuminated region is strip-shaped. If the examined container has an axial direction, the strip may have its largest dimension in the axial direction of the container or parallel to this axial direction. From a different point of view, the illuminated region has its smallest dimension in the circumferential direction of the container, i.e. in the direction of the relative movement between the container and the illuminated region.

In a spatial direction, preferably transverse to the circumferential direction of the container, the illuminated region preferably has a length that is at least as large as the corresponding dimension of the code surface area. This has the advantage that the image of the code has to be assembled only “one-dimensionally” from the series of individual frames, i.e. scanning only takes place in a single spatial direction.

In the circumferential direction of the container, the illuminated region preferably has a width of at most 7 mm (provided that this is still smaller than a width of the code surface area in the circumferential direction of the container). This allows the illumination to be concentrated on a very narrow region.

Even more preferably, the illuminated region has a width of only 3 mm to 6 mm, preferably a width of 4 mm to 5 mm, in the circumferential direction of the container. This can suffice to cover a code with a code surface area of e.g. 8×8 mm with a comparatively small number of individual frames.

It may be advantageous when, during the generation of the series of individual frames, the relative movement between the container and the illuminated region takes place continuously. This has the advantage that repeated deceleration and acceleration of the container can be avoided, the reading of the code being thus accelerated. In an alternative variant, the relative movement between the container and the illuminated region takes place intermittently between two respective individual frames of the series. This variant is advantageous insofar as the container stands still during the generation of an individual frame, so that the image quality of the virtual version of the code will be improved by the elimination of motion blur in the images.

In each of the above variants, the relative movement between the container and the illuminated region can be generated by e.g. rotating the container about an axis and/or by a translational movement.

When the container is already axially symmetrical, such as a bottle, the axis of rotation of the relative movement may be the axis of the container. For generating the relative movement, the container may be placed on a turntable, by way of example, or in a star wheel of an inspection module (of e.g. a glass molding machine). In addition or as an alternative, the container can be gripped by a gripper device and rotated. A translational movement can be generated by placing the container or the turntable or the star wheel on a sliding table that can be driven by a motor (e.g. a stepper motor or a servo motor).

The present invention also relates to a device for reading a code arranged on a wall of a container, the device including a light source for generating an illuminated region on the container and a camera for recording individual frames. According to the present invention, the camera used is a matrix camera, and the light source is—with the container inserted in the device—configured to generate on the container an illuminated region having a width of at most 7 mm in a circumferential direction of the container, the device further including an evaluation unit that is configured to assemble an image of the code from a series of individual frames. The use of a matrix camera and a light source having, in comparison with the prior art, a very narrow width of the illuminated region generated thereby offers the advantages explained above. The evaluation unit may be part of a computer device. The computer device may be configured as a control unit of the device.

Preferably, the light source is configured to generate a strip-shaped illuminated region on the container. The advantage of such a strip-shaped illuminated region is that a particularly simple assembly of the overall image of the code is possible by means of a one-dimensional, i.e. linear, scan.

Preferably, the light source is configured to generate on the container an illuminated region having a width of 3 mm to 6 mm, more preferably a width of 4 mm to 5 mm, in a circumferential direction of the container. These dimensions proved to be particularly advantageous for allowing codes with typical code surface areas of up to 8×8 mm or 10×10 mm to be read making use of a comparatively small number of individual frames.

It will be advantageous when the illuminated region transverse to the circumferential direction of the container, i.e. preferably parallel to an axial direction of the container, has a length that is at least as long as a dimension of the code surface area in the corresponding spatial direction.

The device includes expediently a drive for generating a relative movement between the container and the illuminated region. In order to do so, the light source or an illumination arrangement could actually be moved around the container. However, it turned out that it is more advantageous when a rotational movement of the container is generated. To achieve this, the container can, for example, be placed on a turntable or in a star wheel belonging to an inspection machine, or it can be gripped and rotated by appropriate rotatable grippers.

According to a further development, the device includes a variable diaphragm for changing the width of the illuminated region in the circumferential direction of the container. This offers the advantage of allowing easy adaptation of the device to different container sizes or different shapes of the code and an influence on the width of the illuminated region (or illuminated strip).

It may be advantageous when the light source includes a contrast-enhancing filter. This will improve the quality of the frames and make it easier to read the code.

The method or the device can be used, for example, in the star wheel of an inspection machine, which in turn may be part of a glass molding machine or may be arranged downstream of the latter.

### BRIEF DESCRIPTION OF THE DRAWINGS

In the following, an advantageous embodiment of the present invention will be explained in more detail with reference to a drawing. In more detail,

FIG. 1 shows a representation of a container to be inspected, the container having a code,

FIG. 2 shows a schematic side view of an embodiment of a device according to the present invention,

FIG. 3 shows a top view of the device according to FIG. 2,

FIG. 4 shows a schematic representation for making the “illuminated region” understandable, and

FIG. 5 shows in a schematic representation how a code is covered with a series of individual frames.

### DETAILED DESCRIPTION OF THE INVENTION

Corresponding components are provided with the same reference numerals throughout the Figures.

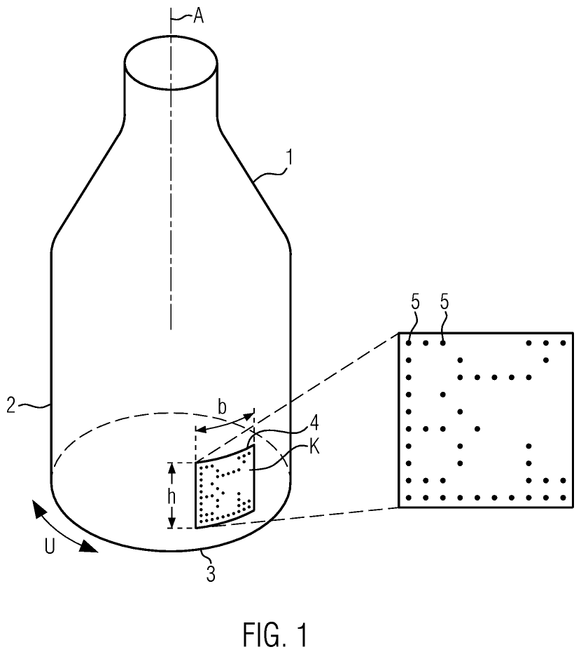

FIG. 1 shows a container 1 to be inspected. The container 1 may, but need not necessarily, be transparent or at least translucent, it may for example be made of glass or plastic. It may be bottle-shaped, for example rotationally symmetrical with an axis of symmetry A. However, the container 1 may also have other than circular cross-sections, for example elliptical or polygonal cross-sections.

The container 1 has a wall 2 and a bottom 3. A code K, which occupies a code surface area 4, is provided on the wall 2 of the container. The code surface area 4 has a width b in a circumferential direction U of the container 1, a height h parallel to the axial direction A of the container 1. The width b and the height h may, for example, each be between 7 mm and 12 mm, for example each 8 mm or each 10 mm.

In the enlarged representation of the code K in FIG. 1, it can be seen that the code K consists of a matrix-shaped arrangement of individual code elements 5. The individual code elements 5 are produced as an embossment or as a depression in the wall 2 of the container 1, for example during molding of the container 1 in a glass molding machine. Alternatively, the code may also be applied after the actual glass molding process, for example by producing it making use of high-energy laser radiation. Each individual code element 5 is dimensioned such that, at its location, the extent of the reflectivity and/or transmissivity of the wall 2 of the container 1 differs significantly from the areas of the container wall 2 having no such code element 5.

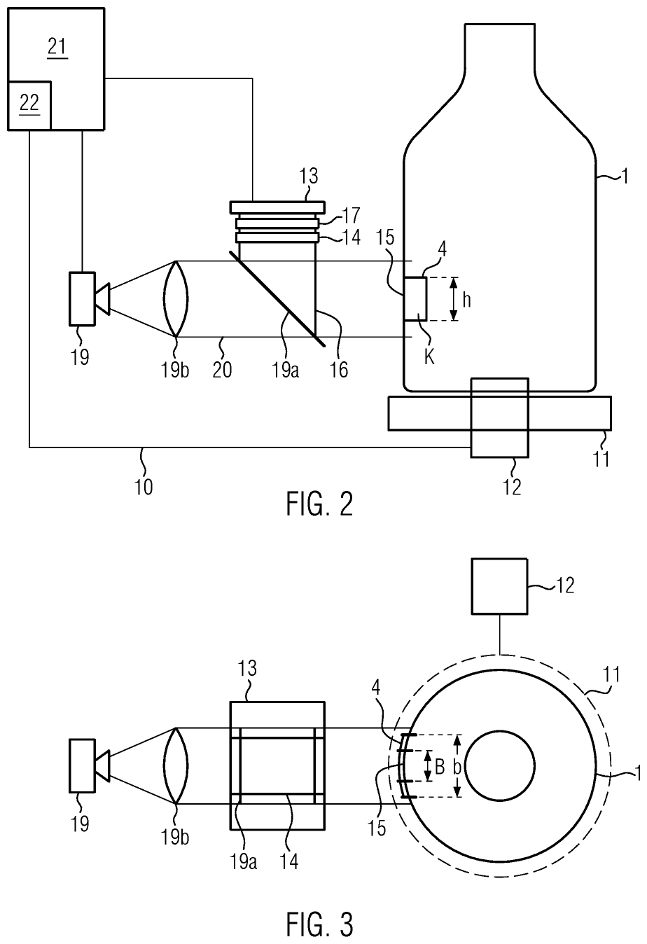

FIG. 2 shows a schematic representation of a side view of a device 10 according to the present invention for reading a code K on the wall 2 of the container 1. The device 10 includes a turntable 11 or a star wheel 11 on, or in which the container 1 to be inspected can be placed. The turntable/star wheel 11 can be driven to rotate by means of a drive 12, for example a servo drive. Preferably, an axis of the rotational movement of the turntable 11 coincides with the axis of symmetry A of the container 1. As an alternative to a turntable 11, a movement of the container 1 within the device 10 can be generated in any other way, for example in a translational manner instead of or in addition to a rotational movement.

A light source 13 generates light that is collimated by a diaphragm 14 onto an illuminated region 15 on the wall 2 of the container 1. The illuminated region 15 has, in the circumferential direction U of the container 1, a width B that is smaller than the width b of the code surface area 4. It follows that, in the circumferential direction U of the container 1, not the entire width b of the code surface area 4 is covered by the illumination generated by the light source 13.

In the beam path 16 of the light generated by the light source 13, one or more further optical elements 17, for example a diffuser 17 (for generating a more uniform, more homogeneous light distribution) and/or a contrast-enhancing filter 17, may optionally be provided.

The device 10 also includes a camera 19, specifically configured as a matrix camera 19, i.e. as a camera with a matrix-shaped, two-dimensional arrangement of light-sensitive elements (or pixels). A field of view 20 of the camera is directed at the container 1 and is large enough to cover at least the illuminated region 15, and preferably large enough to cover the entire code surface area 4. However, the field of view 20 of the matrix camera 19 could also be chosen to be narrower, even narrower than the width B of the illuminated region 15. A beam splitter 19a is arranged such that, at the location of the container 1, the beam path 16 of the light generated by the light source 13 and the field of view 20 of the camera 19 are at least essentially coaxial to one another. In the illustrated embodiment, the path of the rays from the container 1 to the camera 19 is essentially horizontal and perpendicular to the axis A of the container 1. The light source 13 is arranged above this path and emits, in this embodiment, its light vertically downwards until it is deflected by the beam splitter 19a. Alternatively, the positions of the light source 13 and the camera 19 could, for example, be exchanged.

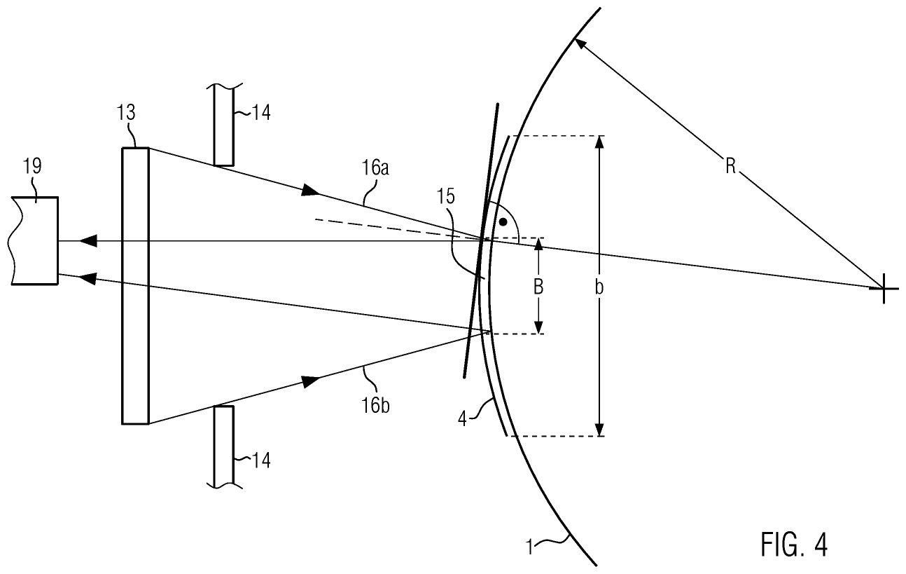

Telecentric optics 19b are integrated in the camera 19 or arranged in front of it, so that the field of view 20 of the camera 19, i.e. the beam path of the light captured by the camera 19, extends, at least largely, parallel between the container 1 and the telecentric optics 19b. In the case of a container 1 with a curved side wall (as shown), for example a glass bottle, the camera 19 thus captures the full height of the illumination from the light source 13, while the width B of the captured area of the illuminated region 15 is further limited by the curvature of the container wall and the resultant lateral deflection of the light rays. Details concerning the limitation of the illuminated region 15 will be explained hereinafter on the basis of FIG. 4.

A computer device 21 controls the operation of the device 10. It includes an evaluation unit 22 that is configured to assemble an overall image of the code K from individual frames recorded by the matrix camera 19, and to read the code. The computer device 21 may include a memory for storing individual frames or also composite digital or virtual images of the code K. The computer device can be in operative communication with the light source 13, the drive 12 and the matrix camera 19, so as to control and coordinate these components of the device 10.

FIG. 3 shows, in a top view, the device 10 according to FIG. 2. It can be seen here that the light source 13 and the diaphragm 14 in front of it are arranged above the light path between the container and the telecentric optics 19b. The width of the captured or illuminated region of the illuminated area 15 is identified by B, the width of the code K is identified by b. Preferably, the axis A of the container 1 coincides with the axis of the turntable 11, so that the position of the outer surface of the container 1 preferably does not change during the rotation of the container 1.

FIG. 4 helps to understand how the term “illuminated region” is to be understood in the context of the present invention. The container 1, the light source 13 and the matrix camera 19 are shown in FIG. 4 schematically—and in particular independently of their actual geometric arrangement. In the present example, the container 1 has a convexly curved outer surface with a radius of curvature R around the axis A of the container 1. A code surface area 4 on the surface of the container 1 contains the code K. In the circumferential direction U of the container 1, the code surface area 4 has a width b.

Light falling from the light source 13 onto the container 1 is reflected at the surface of the container 1 according to the rule “angle of incidence=angle of reflection” before it reaches the matrix camera 19. FIG. 4 shows the outer marginal rays 16a of the light emitted by the light source 13, which just reach the matrix camera 19. The outer marginal rays 16a are here determined by the respective distances between the light source 13, the diaphragm 14 and the container 1, by the lateral dimensions of the light source 13 and the diaphragm 14, and by the radius of curvature R of the wall 2 of the container 1. The illuminated region 15 is now the region on the container 1 that is delimited by the marginal rays 16a. In other words: the illuminated region 15 is the region on the surface of the container 1 from which light is reflected from the light source 13 onto the matrix camera 19. The size of this illuminated region 15 in the circumferential direction of the container 1 is defined by the dimensions of the light source 13, the size of the opening in the diaphragm 14, the respective distances between the light source 13, the diaphragm 14 and the container 1, and by the radius of curvature R of the surface of the container 1. This means that, if, for example, the curvature of the surface of the container 1 decreases, i.e. the radius of curvature R increases, the width B of the illuminated region 15 would also increase. In order to keep the width B of the illuminated region 15 constant, and in order to limit it, the dimensions of the light source 13 or—preferably—the opening width of the diaphragm 14 would have to be reduced as a countermeasure. The method according to the present invention and the device according to the present invention are configured under these aspects in such a way that the width B of the illuminated region 15 on the container 1 is smaller than a width b of the code surface area 4 in the circumferential direction U of the container 1. Preferably, the illuminated region 15 has a width B of at most 7 mm or of only 3-6 mm in the circumferential direction U.

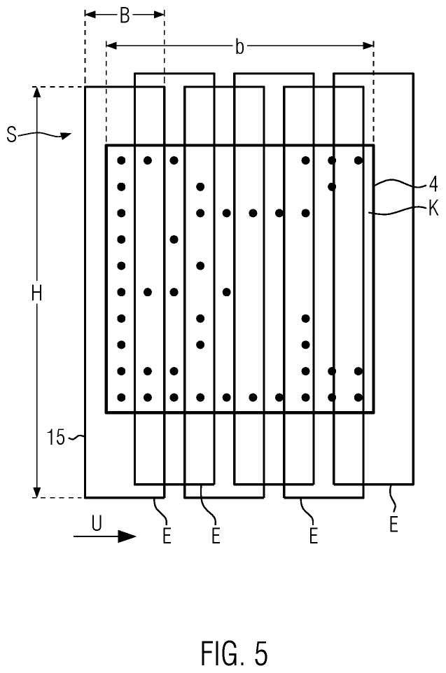

FIG. 5 shows schematically how the code K on the container is read using the method according to the present invention and the device 10 according to the present invention. In order to obtain an image of the entire code, a series S of individual frames is generated by means of the matrix camera, with the individual frames E of the series S being arranged and dimensioned such that, in their entirety, they cover the code surface area 4 of the code K. Each individual frame E is two-dimensional, since the camera is a matrix camera 19. The individual frame E has a width and a height H. The region that is adapted to be used for reading the code K is, however, limited by the illuminated region 15, which is generated by the light source 13 on the wall 2 of the container 1. For a better understanding, FIG. 5 therefore shows for each individual frame E only the optically evaluable region that corresponds to the illuminated region 15 and thus has a width B and a height H. The height H of the illuminated region 15, which is strip-shaped in the case of the present embodiment, may be greater than the height h of the code surface area 4, while the width B of the illuminated region 15 is smaller than the width b of the code surface area 4 in the circumferential direction U of the container. For example, the width B of the illuminated region 15 may be from 4 mm to 6 mm, preferably 5 mm, when the code K occupies a code surface area 4 of 8×8 mm.

In FIG. 5, the code surface area 4 is covered with a series S of a total of six individual frames E. However, this number is freely selectable, depending on the type of matrix camera 19 used, the size of the code surface area 4 or the type of container 1. For example, a series S can include between five and one hundred individual frames E.

Between the recording of two neighboring individual frames E, a respective relative movement takes place between the illuminated region 15 and the container 1 in the circumferential direction U of the container 1. This relative movement may, for example, be selected to be so large that two neighboring individual frames E overlap with each other over up to 30%, up to 40% or also up to 50% or up to 60% or up to 90% of their width B. The overlapping of neighboring individual frames E facilitates the recognition of identical structures in the neighboring individual frames E and thus the assembling of an overall image of the code K from the series S of individual frames E. This assembling or reading of the code K can be carried out in the evaluation unit 22, but can also optionally take place outside the device 10. In the latter case, the device 10 would only generate the individual frames E.

In addition, FIG. 3 can also be regarded as a representation of an overall image of the code K assembled from the individual frames E (in particular by image processing, e.g. by means of an algorithm, in particular of an artificial intelligence, AI).

The diaphragm 14 used in the device 10 in the beam path 16 of the light source 13 can be a fixed diaphragm. Alternatively, the diaphragm 14 can be variable, so as to allow the width B of the illuminated region 15 to be changed. This configuration makes the device 10 more easily adaptable to different container sizes and shapes.

Taking as a basis the described embodiments, the device and the method can be modified and adapted in a variety of ways. For example, a matrix camera 19 with a size of at least 500×120 pixels, e.g. with a size of 640×190 pixels, may be used as the camera. The recording frequency of the matrix camera 19 may be greater than 400 Hz, preferably greater than 800 Hz, even more preferably in the range of 1000-1200 Hz. The number of individual frames E in a series S for covering the code surface area 4 of a code K may, for example, be 10-120, preferably 50-100. The light source 13 may be a continuous light source, i.e. it may emit light continuously during the recording of a series S of individual frames E. Alternatively, the light source 13 may be a stroboscopic light source.

Further amendments are certainly conceivable. All the features described in connection with the method according to the present invention can also be used, individually or in arbitrary combination, in the device according to the present invention, and vice versa.

1. A method for reading a code arranged on a wall of a container, the code occupying a code surface area on the wall of the container, characterized by the following steps:
generating an illuminated region on the wall of the container by means of a light source, a width of the illuminated region being smaller than a width of the code surface area in a circumferential direction of the container,
generating a relative movement between the container and the illuminated region,
generating a series of individual frames of the illuminated region by means of a matrix camera, a relative movement between the container and the illuminated region taking place between individual frames of the series,
assembling an image of the code from the series of individual frames.

2. The method according to claim 1, characterized in that the code is configured as an arrangement of embossments and/or depressions in the wall of the container, preferably in a matrix shape.

3. The method according to claim 1, characterized in that at least one individual frame of the series, preferably all the individual frames of the series, overlap(s) with a neighboring individual frame.

4. The method according to claim 1, characterized in that the illuminated region is strip-shaped.

5. The method according to claim 1, characterized in that the illuminated region has a width of at most 7 mm in the circumferential direction of the container.

6. The method according to claim 1, characterized in that the illuminated region has a width of 3 to 6 mm, preferably a width of 4 to 5 mm, in the circumferential direction of the container.

7. The method according to claim 1, characterized in that, during the generation of the series of individual frames, the relative movement between the container and the illuminated region takes place continuously or intermittently between two respective individual frames of the series.

8. The method according to claim 1, characterized in that the relative movement between the container and the illuminated region is generated by a rotation of the container about an axis.

9. A device for reading a code arranged on a wall of a container, comprising a light source for generating an illuminated region on the container and a camera for recording individual frames, characterized in that the camera is a matrix camera, that the light source is configured to generate on the container an illuminated region having a width of at most 7 mm in a circumferential direction of the container, and that the device includes an evaluation unit that is configured to assemble an image of the code from a series of individual frames.

10. The device according to claim 9, characterized in that the light source is configured to generate a strip-shaped illuminated region on the container.

11. The device according to claim 9, characterized in that the light source is configured to generate on the container an illuminated region having a width of 3 to 6 mm, preferably a width of 4 to 5 mm, in a circumferential direction of the container.

12. The device according to claim 9, characterized in that it includes a drive for generating a relative movement between the container and the illuminated region, preferably for generating a rotational movement of the container.

13. The device according to claim 9, characterized in that it includes a variable diaphragm for changing the width of the illuminated region in the circumferential direction of the container.

14. The device according to claim 9, characterized in that the light source includes a contrast-enhancing filter.
